(19) United States
(12) Patent Application Publication
(10) Pub. No.: US 2020/0028594 A1
(43) Pub. Date: Jan. 23, 2020

(54) Electromagnetic wave induction device and switch using the same

(71) Applicants: Sichuan University, Chengdu (CN); NORTHWESTERN POLYTECHENICAL UNIVERSITY, Xi'an Shaanxi (CN)

(72) Inventors: Xiaoqing Yang, Chengdu (CN); Heng Jing, Chengdu (CN); Shiyue Wu, Chengdu (CN); Jianping Yuan, Xi'an (CN); Zhanxia Zhu, Xi'an (CN)

(73) Assignees: Sichuan University; NORTHWESTERN POLYTECHENICAL UNIVERSITY

(21) Appl. No.: 16/228,791

(22) Filed: Dec. 21, 2018

(30) Foreign Application Priority Data
Sep. 30, 2018 (CN) 201811160825.4

(51) Int. Cl. H04B 10/90

(52) U.S. Cl. CPC H04B 10/90

(57) ABSTRACT

An electromagnetic wave induction device using smoke instead of antennas and a switch using the same adopt the smoke to realize the induction of the electromagnetic wave signal, and the smoke replaces the antenna as the receiving device, which is not susceptible to the environment and can be applied to occasions where antenna is limited. Smoke can reduce the safety hazard caused by the antenna, and can be recognized by the naked eye, so as to intuitively read signal transformation and realize the visualization of electromagnetic wave signal induction. Compared with the conventional electromagnetic wave induction device, the present invention provides a brand-new electromagnetic induction device. The antenna of the receiving portion is replaced by the smoke in the experimental cavity, and the smoke is directly used as a signal receiving device, which overcomes the antenna constraints in prior art.

### CROSS REFERENCE OF RELATED APPLICATION

The present invention claims priority under 35 U.S.C. 19(a-d) to CN 201811160825.4, filed Sep. 30, 2018.

### BACKGROUND OF THE PRESENT INVENTION

### Field of Invention

The present invention relates to a technical field of electromagnetic wave induction, and more particularly to an electromagnetic wave induction device and a switch using the same.

### Description of Related Arts

Electromagnetic waves are oscillating particle waves that are generated by electric and magnetic fields which are in-phase and perpendicular to each other. They are electromagnetic fields transmitting in the form of waves, and have wave-particle duality. Electromagnetic waves are moved in the form of waves in space by electric and magnetic fields that oscillate in phase and are perpendicular to each other. Electromagnetic radiation from low frequency to high frequency is mainly divided into: radio waves, microwaves, infrared, visible light, ultraviolet light, X-rays and gamma rays. Radio waves are used for communication. Microwaves are used for microwave ovens, satellite communications, etc. Infrared is used for remote control, thermal imagers, infrared guided missiles, etc. Visible light is the basis for most organisms to observe things. Ultraviolet rays are used for medical disinfection, money detection, distance measurement, engineering flaw detection, etc. X-rays are used for CT photography. Gamma rays are used for treatment and atomic transitions for new rays.

Wireless communication is a communication method in which information is exchanged, which uses characteristics that electromagnetic wave signals can transmit in free space. The conventional wireless communication is based on the phenomenon of electromagnetic induction. After the data to be transmitted is processed with low frequency carrier modulation, signal amplifying and power amplifying, the electromagnetic wave is generated by the transmitter. When the electromagnetic wave transmits in space, an induced current will be generated in an encountered conductor. When the natural frequency of the receiving circuit is the same as the frequency of the received electromagnetic wave, the oscillating current generated in the receiving circuit is the strongest. After the induced current is processed with signal treatments such as filtering, demodulating and decoding, the transmitted information is received at the receiving end, thereby completing communication process.

In the conventional antenna signal transmission system, the signal transmission process is as follows:

(1) The antenna converts the local signal into free space radiation;

(2) The radiation transmits away from the antenna for a relatively long distance:

(3) Another antenna detects the radiation and converts it into a received signal.

In this kind of wireless communication, the receiving end antenna is an essential component, and it cannot be applied in some special occasions such as a concentrated lightning area. Furthermore, the antenna may increase the risk of electric shock, introducing a safety hazard. The signal received by the antenna needs complicated signal processing before being presented in visual or auditory form. Conventionally, there is no method for receiving radio waves and microwave signals instead of electromagnetic induction. Chinese patent CN108363052A discloses an indoor positioning system and method based on visible light communication, which uses a monochromatic light LED that emits visible light other than the light component of the indoor illumination lamp, and transmits a unique ID by using the monochromatic light LED in the signal transmitter; and then the unique ID signal is prevented from being interfered by the indoor illumination lamp through setting a filter at the receiving end of the photodetector of the signal receiver, which improves the accuracy and efficiency of the signal receiver for receiving the unique ID signal; the signal receiver converts the received unique ID monochromatic optical signal into an electrical signal, and the matching relationship with the signal transmitter is sent to the server. Since one of the signal transmitter and the signal receiver is a fixed end, the server can determine positions of the signal transmitter and the signal receiver, so as to achieve indoor positioning. This scheme enables communication without an antenna, but such communication is limited to short-range communication and is susceptible to environmental interference.

### SUMMARY OF THE PRESENT INVENTION

The inventors of the present invention have found that electromagnetic waves affect the rising form of smoke in the air, and on the basis of this, provide an electromagnetic wave induction device using smoke instead of antennas, and provide a switch using the same. The present invention utilizes the smoke to realize the induction of the electromagnetic wave signal, and the smoke replaces the antenna as the receiving device, which is not susceptible to the environment and can be applied to occasions where antenna is limited. Smoke can reduce the safety hazard caused by the antenna, and can be recognized by the naked eye, so as to intuitively read signal transformation and realize the visualization of electromagnetic wave signal induction. Compared with the conventional electromagnetic wave induction device, the present invention provides a brand-new electromagnetic induction device. The antenna of the receiving portion is replaced by the smoke in the experimental cavity, and the smoke is directly used as a signal receiving device, which overcomes the antenna constraints in prior art.

Accordingly, in order to accomplish the above objects, the present invention provides:

an electromagnetic wave induction device, comprising a smoke space limited by a cavity in which charge-carrying smoke is disposed.

The smoke is used to detect changes in the electromagnetic wave signal. The presence of electromagnetic waves changes the laminar flow height of the smoke. The laminar flow height of the smoke is the height at which the plume rises steadily. The laminar flow height of the smoke is reduced with the electromagnetic wave. The laminar flow height of the smoke rapidly returns to an original height when electromagnetic radiation is turned off. The laminar flow height changes of the smoke can be reflected in the short time after adding and removing the electromagnetic waves, which is similar to on and off operations of a switch, and meanwhile reflects a non-contact characteristic.

Preferably, the electromagnetic wave induction device further comprises an image signal collector and an image signal analyzer, wherein the image signal collector collects an image signal of the smoke, and transmits the image signal to the image signal analyzer; the image signal analyzer analyzes laminar flow height changes of the smoke. The image signal collector can be placed according to an actual situation, which can be placed inside the cavity or outside the cavity.

Optionally, the smoke is produced by burning a combustion material which is coal, wood, cotton, hemp, paper, cigarettes, etc.

Preferably, the combustion material is burnt to produce white smoke, which is natural silk, cotton, hemp, paper, cigarettes, and the like. Although the smoke generated by burning the raw materials in the present invention can be replaced by other charge-carrying smoke, when the smoke gradually increases, the visibility inside the cavity is gradually reduced. In order to better read the data, the raw materials producing the white smoke are preferred.

Optionally, the smoke is generated by a smoke generator, and the space ions are excited by a strong electrode, in such a manner that the smoke passes through the space ions and carries charge.

The cavity is used to limit the smoke to a certain range to reduce the effects of the external environment. In the cavity, the electromagnetic wave signal is converted into an observable signal of smoke height changes, reflecting transformation of the electromagnetic wave signal.

Preferably, the cavity is transparent.

Preferably, the combustion material is placed inside the cavity.

Preferably, the cavity has a top cover which is slidable, so as to easily place the combustion material into the cavity; guide rails are respectively provided at opposite sides on a top of the cavity; the top cover is slidable along the guide rails to open or close the transparent cavity, which enables two slightly different environments, wherein one is opened and the other is closed, one environment is transformed to the other through sliding the top cover.

Preferably, a size of the cavity is 20×20×40 cm; since the particles carry a certain amount of charge after burning, the cavity is preferably made of a 5 mm-thick antistatic polycarbonate plate to prevent static electricity from affecting the result.

In order to minimize an effect of a wall on the result, it is preferred to place the combustion material at a bottom center of the cavity.

Preferably, the electromagnetic wave induction device further comprises an illumination system, and the laminar flow height change of the smoke is highlighted by the illumination system.

The illumination system produces a visible light beam with better focusing ability, which is preferably placed at a top portion the cavity. The illumination system with better focusing ability is used to highlight state changes of the smoke. As the concentration of smoke increases, the visibility inside the cavity gradually decreases. The visible beam with better focusing ability can better highlight the state changes of the smoke, so as to better read the data.

The present invention also provides an electromagnetic induction switch, comprising an electromagnetic wave induction device mentioned above, an electromagnetic signal transmitter, an image signal collector and an image signal analyzer.

The image signal collector collects an image signal of the smoke, and transmits the image signal to the image signal analyzer; the image signal analyzer analyzes laminar flow height changes of the smoke, so as to obtain a switch signal corresponding to a microwave signal.

The electromagnetic signal transmitter is a high frequency electromagnetic wave transmitter, which may be a klystron, a magnetron, an effect tube or solid-state components. A preferred output frequency is 900 MHz.

Preferably, the electromagnetic signal transmitter transmits a modulated electromagnetic wave.

Preferably, a transmission power of the electromagnetic signal transmitter is adjustable, and is controlled by an external signal.

Preferably, the electromagnetic induction switch further comprises an antenna, wherein the antenna is used to convert an electromagnetic wave into an electromagnetic wave transmitted in a free space. The antenna may be a parabolic antenna, a horn parabolic antenna, a horn antenna, a lens antenna, a slotted antenna, a dielectric antenna, a periscope antenna, or the like. The antenna is preferably a horn antenna.

The cavity is placed in a transmitting antenna far field region, and a power density in the cavity is not less than 10 mw/cm². In this region, electromagnetic waves can be regarded as plane waves and field distribution is stable. The region varies depending on a frequency at which the electromagnetic waves are transmitted.

The electromagnetic induction switch can be applied to various fields of social production and life such as aerospace, locomotive ships, military weapons, power generation and distribution, post and telecommunications, metallurgical mines, automatic control, household appliances, instrumentation and scientific research experiments, such as ignition control system and illumination systems.

The present invention has the following beneficial effects:

1. The present invention utilizes electromagnetic waves for signal transmission, the electromagnetic wave transmission process has small loss, long-distance transmission is possible, it is difficult to be affected by the environment, and better quantization of signal changes is provided.

2. Compared with the conventional antenna electromagnetic induction receiver, the present invention utilizes the smoke to realize the induction of the electromagnetic wave signal, and the smoke replaces the antenna as the receiving device, which is not susceptible to the environment and can be applied to occasions where antenna is limited. Smoke can reduce the safety hazard caused by the antenna, and each component can be flexibly placed in different positions.

3. The antenna of the receiving portion of the present invention is replaced by the smoke in the experimental cavity which is transparent, and the illumination system is used to highlight the state change of the smoke, wherein the smoke is used to to visually read the signal transformation (visualization of signal transformation). The signal change can be easily observed by the human eyes, so as to intuitively read the signal transformation and realize the visualization of the electromagnetic wave signal induction. The signal collector and the image signal analyzer are adopted, and the present invention can be applied to the automatic system to realize accurate reading of the signal.

4. The transparent cavity of the present invention is made of antistatic polycarbonate plates, which can effectively prevent static electricity from affecting the result.

### BRIEF DESCRIPTION OF THE DRAWINGS

FIG. 1 is a sketch view of an electromagnetic wave induction device of the present invention.

FIG. 2 is a sketch view of an electromagnetic induction switch of the present invention.

FIG. 3 is a system structural view of the electromagnetic induction switch of the present invention.

FIG. 4 illustrates electromagnetic field distribution excited by a horn antenna.

FIG. 5 is a system flow chart of the electromagnetic induction switch of the present invention.

FIGS. 6a-6c illustrate experimental results of an embodiment 1.

FIGS. 7a-7c illustrate experimental results of an embodiment 2.

FIGS. 8a-8b illustrate laminar flow height changes of smoke according to the embodiment 1 and the embodiment 2.

FIG. 9 is a distance zonal diagram of smoke particles in simulation analysis of an electromagnetic wave affecting a laminar flow height;

FIGS. 10a-10d illustrate distribution of the smoke particles over time in different distance intervals in the simulation analysis of the electromagnetic wave affecting the laminar flow height.

Element reference: 1—smoke space, 2—image signal collector, 3—image signal analyzer, 4—transparent cavity, 5—combustion material, 6—illumination system, 7—microwave signal source, 8—transmission line, 9—horn antenna.

### DETAILED DESCRIPTION OF THE PREFERRED EMBODIMENT

Objectives, features, and advantages of the present invention will become apparent from the following detailed description, the accompanying drawings, and the appended claims. Embodiments will be shown and described for the purposes of illustrating the functional and structural principles of the present invention and is subject to change without departure from such principles.

Firstly, the theoretical analysis of how the electromagnetic wave affects the laminar flow height changes of the plume airflow is illustrated, and the feasibility is further demonstrated through simulation analysis.

I. Theoretical Analysis

As described in many other inflation gas charging methods, combustion causes charge quantity carried by the smoke to be slightly more than an equilibrium charge quantity. Studies have shown that under the action of periodic electric fields, the trajectory of unipolar charged particles changes with the change of electric field. Aerosol clusters as a nonlinear system are affected by various effects, and slight disturbances may lead to some interesting changes.

Studying the behavior of aerosol clouds allows us to explore the motion laws of smoke in an electromagnetic environment. Aerosol clouds are defined as areas with clear boundaries against surrounding medium. Due to the interaction between these high concentration particles and the resistance generated by the molecules from the surrounding medium entering the aerosol system, the surrounding medium flows around the aerosol system rather than through it. Therefore, the aerosol system moves like a solid. The behavior of the aerosol cloud can be summarized by a parameter G as follows:

$$G = \frac{12 μ}{{ρ}_{p} {d}_{ave}^{2} {C}_{s , ave}} {( \frac{2 {ρ}_{c} {d}_{c}}{{C}_{D } {ρ}_{g} g} )}^{1 / 2} \qquad ( 1 )$$

wherein μ is a viscosity of the surrounding gas, g is a force caused by gravity, d_{c}, ρ_{c} and C_{D} are diameter, density and resistance factor of the cloud. In addition, ρ_{P} and ρ_{g} are particle and gas density, C_{S,ave} is a slip correction factor of the average particle diameter.

According to the experiments, aerosol particles satisfy the condition G>>1, which means that they exhibit cloud behavior and move as a coherent body. In this case, the aerosol system can be considered as a fluid and its motion can be described as laminar, transient or turbulent. According to Reynolds number:

$${R}_{e} = \frac{ρ vd}{η} \qquad ( 2 )$$

wherein ρ, ν, d and η are density, average velocity, characteristic length and dynamic viscosity of the fluid. As the Reynolds number increases, the fluid changes from advection to nonlinear dynamic system, and then to chaotic evolution.

The plume airflow is initially produced by the combustion of cigarettes naturally rises in a layered manner due to buoyancy caused by temperature-dependent density differences. During rising, the viscous forces eliminate any fluid field instability due to environmental disturbances. As the plume rises, various factors make it difficult for the viscous force to keep eliminating these environmental disturbances, thus entering an unstable transitional state that eventually causes the smoke to enter a turbulent state. After analyzing the experimental results, we believe that the electromagnetic wave may affect the smoke particles, so as to change the size of the plume.

II. Simulation Analysis

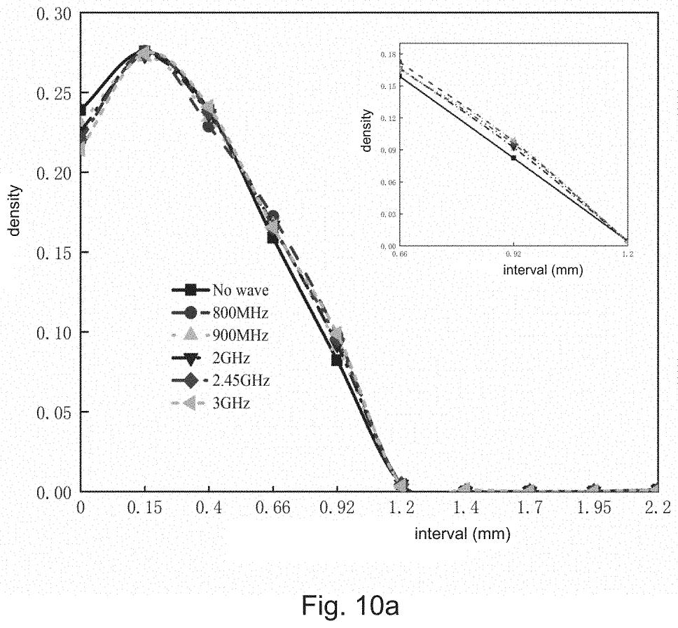

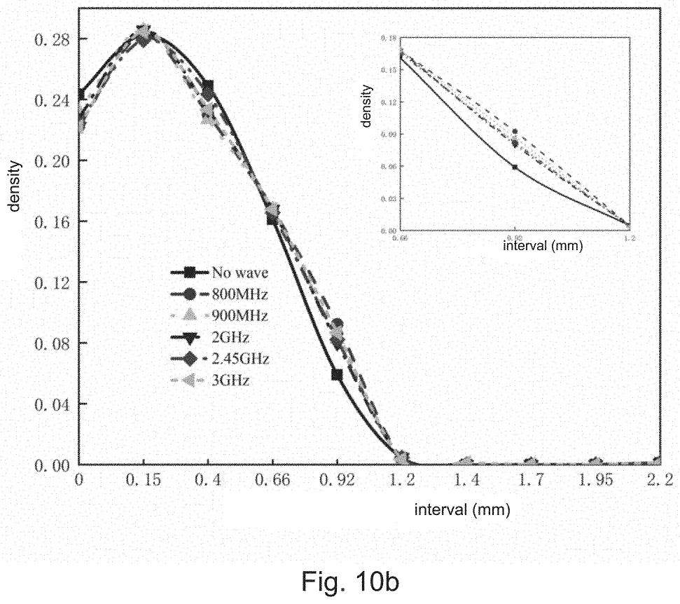

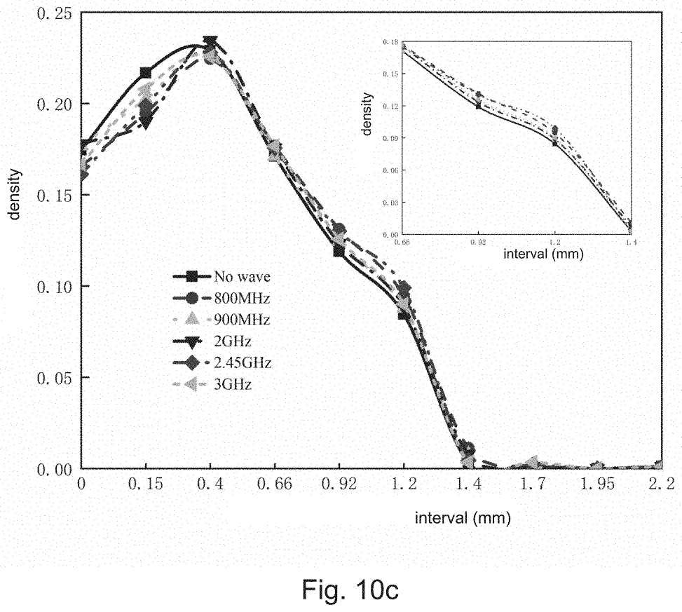

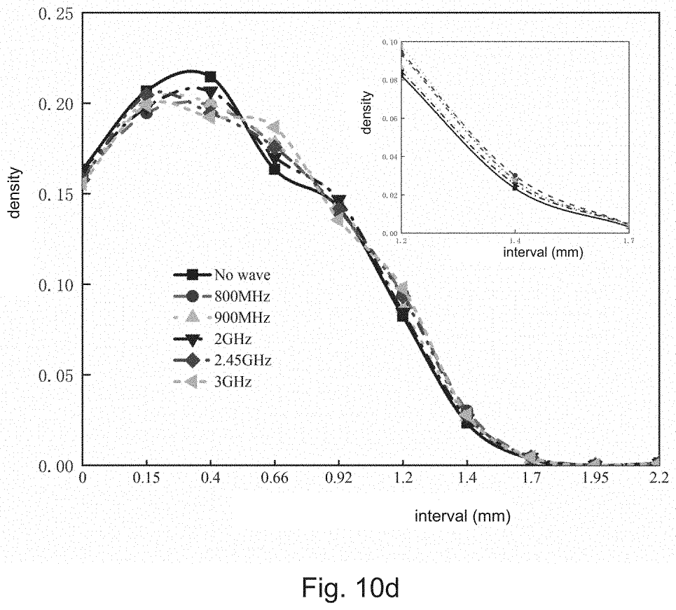

The smoke particle motion simulation is performed to obtain the position of the particle at different moments with or without electromagnetic radiation, and the distance between the current particle position and the center of the particle system is extracted to evaluate the diffusion of the aerosol cloud. Then, the distance from the target particle to the center of the cloud is divided into several different distance intervals at different times. Referring to FIG. 9, the distance of all particles to the center of the cloud is divided into 10 regions, i.e. A-J, and the number of particles in each region is calculated at the time of interest. There is a significant difference in the evolution of particle distribution over these distance intervals, depending on the presence or absence of electromagnetic radiation. FIGS. 10a-10d show the distribution of particles over time in different distance intervals, wherein x-axis and y-axis respectively represent the distance between the particles and the center (with different intervals) and the proportion of particles in each interval. FIGS. 10a-10d respectively show particle dispersion at is, 1.2 s, 1.5 s and 2 s.

A variety of factors can increase in the distance of the particles from the center point of the cloud, which will cause the particles to diffuse. If enough smoke particles are further diffused, the characteristic size of the plume will increase, which means that if the other parameters in equation (2) are constant, the Reynolds number will increase. If the initial small Reynolds number exceeds the critical value, the slightest disturbance will cause a significant change in the smoke state, turning the laminar plume into a turbulent state.

When there is no electromagnetic radiation, there are more particles in several areas near the center (distance is 0), and vice versa in the presence of electromagnetic radiation. The change in the total number of particles in the target area is about 10%, indicating that the electromagnetic wave radiation accelerates the particle diffusion and is particularly effective at frequencies of 800-900 MHz.

In the present invention, the calculated G value is always much greater than 1, which means that the smoke will continue to move as a unique cloud, and the Reynolds number of the cloud increases with its size. In addition to natural diffusion, electromagnetic waves accelerate the diffusion process, further increasing the width of the smoke flow by about 10%. Since there is a linear relationship between feature size and Reynolds number, the Reynolds number is also increased by 10%. If this causes it to exceed a certain threshold, this will fully disrupt the smoke system so that the viscous force can no longer compensate for it, in such a manner that the smoke state will change from laminar to turbulent.

Through the above theoretical analysis and simulation analysis, the feasibility of the remote electromagnetic-smoke switch is fully verified.

The present invention will be further described below in conjunction with the accompanying drawings and embodiments.

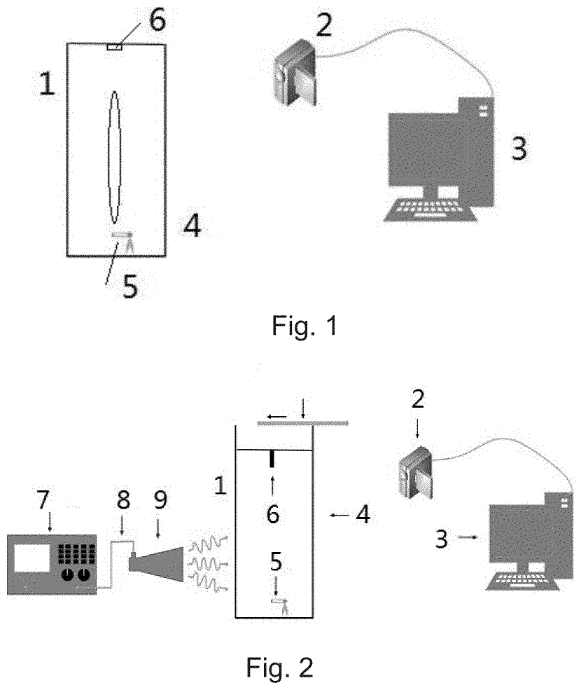

Referring to FIG. 1, an electromagnetic wave induction device of the present invention comprises a smoke space 1 limited by a cavity 4, an image signal collector 2 and an image signal analyzer 3, wherein charge-carrying smoke is disposed in the smoke space 1, the image signal collector 2 collects an image signal of the smoke, and transmits the image signal to the image signal analyzer 3; the image signal analyzer 3 analyzes laminar flow height changes of the smoke.

The cavity 4 is used to limit the smoke to a certain range to reduce the effects of the external environment. The cavity 4 is transparent. The smoke is produced by burning a combustion material 5 in the cavity 4.

The combustion material 5 is cigarettes, and state change of the smoke in the cavity 4 is highlighted by an illumination system 6.

Furthermore, referring to FIG. 2, the present invention provides an electromagnetic induction switch, comprising a microwave signal source 7, a transmission line 8, a horn antenna 9, a transparent cavity 4, a combustion material 5, an illumination system 6, an image signal collector 2 and an image signal analyzer 3; wherein the microwave signal source 7 is a high frequency electromagnetic wave transmitter for transmitting long-distance high-frequency electromagnetic waves, and converting an external signal into an electromagnetic wave signal. In the transparent cavity 4, the electromagnetic wave signal is converted into an observable signal of laminar flow height change of the smoke.

In operation, the output signal of the microwave signal source 7 is transmitted to the horn antenna 9 through the transmission line 8, and the microwave signal is radiated to the space by the horn antenna 9. The microwave signal generated by the microwave signal source 7 can change the laminar flow height of the white smoke, and the laminar flow height change of the smoke is highlighted by the illumination system 6. The image signal collector 2 identifies the laminar flow height change of the smoke, and transmits this signal to the image signal analyzer 3. The image signal analyzer 3 analyzes laminar flow height changes of the smoke, so as to obtain a switch signal corresponding to a microwave signal.

The switch signal is used as an input control signal of a switch module. The electromagnetic induction switch can be applied to various fields of social production and life such as aerospace, locomotive ships, military weapons, power generation and distribution, post and telecommunications, metallurgical mines, automatic control, household appliances, instrumentation and scientific research experiments, such as ignition control system and illumination systems.

The combustion material 5 is burnt to continuously produce smoke, and the smoke is used to detect changes in electromagnetic wave signals. The presence of electromagnetic waves changes the laminar flow height of the smoke. The laminar flow height of the smoke is the height at which the plume rises steadily. The laminar flow height of the smoke is reduced with the electromagnetic wave. The laminar flow height of the smoke rapidly returns to an original height when electromagnetic radiation is turned off. The laminar flow height changes of the smoke can be reflected in the short time after adding and removing the electromagnetic waves, which is similar to on and off operations of a switch, and meanwhile reflects a non-contact characteristic.

The state change of the smoke in the transparent cavity 1 is highlighted by the illumination system 6. Meanwhile, the image signal collector 2 collects and detects motion state of the smoke, and then transmits this signal to the image signal analyzer 3 for analysis. The image signal collector 2 can be placed according to its performance, which can be placed inside the cavity 4 or outside the cavity 4.

The microwave signal source 7 is used for transmitting long-distance high-frequency electromagnetic waves, and converting an external signal into an electromagnetic wave signal. In the transparent cavity 4, the electromagnetic wave signal is converted into an observable signal of laminar flow height change of the smoke. A transmission power of the microwave signal source 7 is adjustable, and is controlled by an external signal, wherein an output frequency is 900 MHz. The electromagnetic wave transmitted by the microwave signal source 7 is a modulated electromagnetic wave.

A size of the cavity is 20×20×40 cm, since the particles carry a certain amount of charge after burning, the cavity 4 is made of a 5 mm-thick antistatic polycarbonate plate to prevent static electricity from affecting the result.

In order to minimize an effect of a wall on the result, it is preferred to place the combustion material at a bottom center of the cavity. The combustion material 5 is a cigarette material which is burnt to produce white smoke.

The illumination system 6 produces a visible light beam with better focusing ability, which is used to highlight state changes of the smoke. As the concentration of smoke increases, the visibility inside the cavity gradually decreases. The visible beam with better focusing ability can better highlight the state changes of the smoke, so as to better read the data.

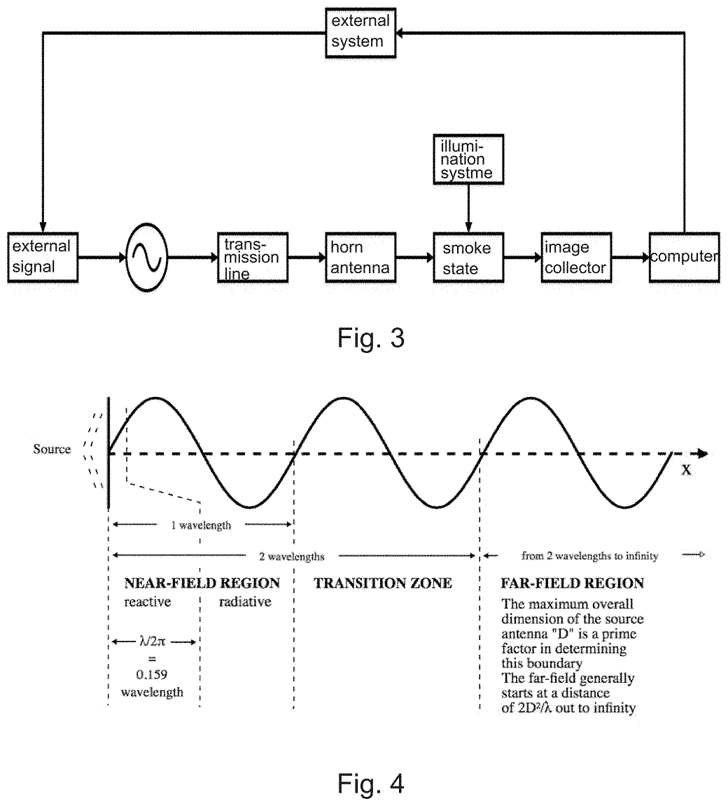

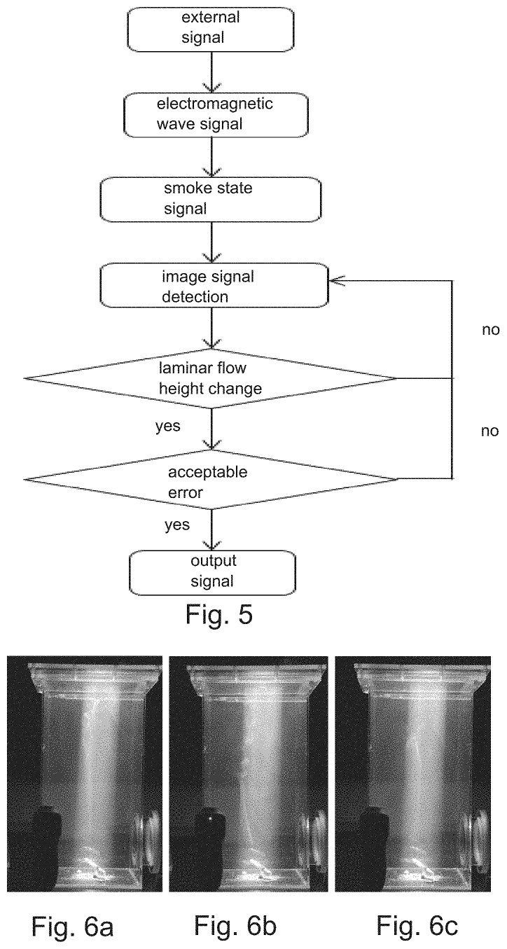

For better presenting transformation of the electromagnetic wave signal, the experimental cavity 4 is placed in a transmitting antenna far field region, and a power density in the experimental cavity 4 is not less than 10 mw/cm². In this region, electromagnetic waves can be regarded as plane waves and field distribution is stable. The electromagnetic field distribution excited by the antenna is shown in FIG. 3.

The cavity 4 has a top cover which is slidable, so as to easily place the combustion material 5 into the cavity 4. The transparent cavity 4 is used to limit the smoke generated by the combustion material 5 to a certain range to reduce the concentration difference between the smoke flow and the internal environment of the cavity 4.

The top cover is provided on the transparent cavity 4, guide rails are respectively provided at opposite sides on a top of the cavity; the top cover is slidable along the guide rails to open or close the transparent cavity, which enables two slightly different environments, wherein one is opened and the other is closed, one environment is transformed to the other through sliding the top cover.

### Embodiment 1

The top cover of the transparent cavity 4 is opened.

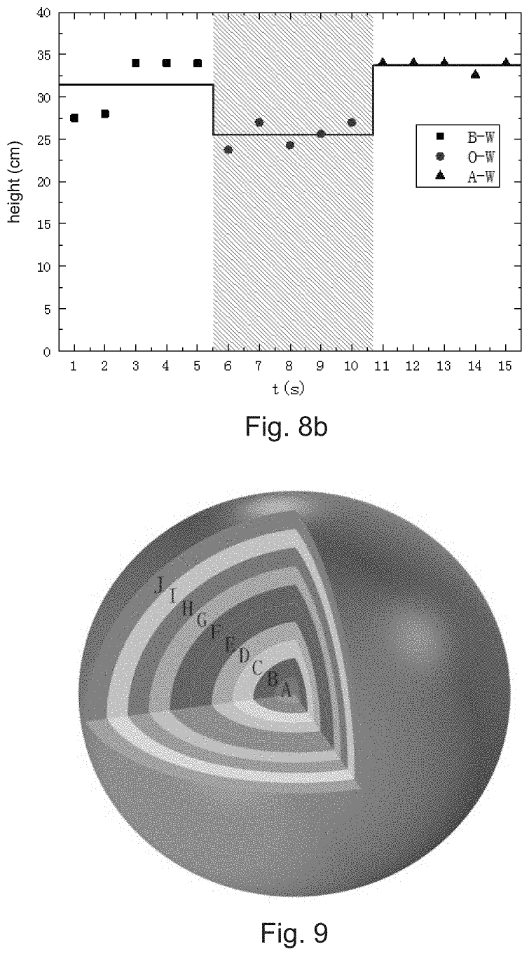

When the electromagnetic radiation is turned on, the laminar flow height of the plume airflow is lowered, and the width of the plume airflow is also significantly increased; when the electromagnetic radiation is turned off, the plume quickly returns to its initial height, and the result is shown in FIGS. 6a-6c. FIG. 6a shows the plume flow before the electromagnetic radiation is turned on. FIG. 6b shows the plume flow 1 second after the radiation is turned on. FIG. 6c shows the plume flow 2 seconds after the radiation is turned off again. White light columns are for lighting only. The red dot on the microwave leak detector in FIG. 6b indicates the presence of electromagnetic waves. The laminar flow height change of the plume over time is shown in FIG. 8a, wherein the x-axis and the y-axis respectively show time (s) and laminar flow height (cm). Changes are significant before the electromagnetic radiation is turned on (B-W, square), during the electromagnetic radiation is turned on (O-W, dot), and after the electromagnetic radiation is turned off again (A-W, triangle). The discrete points in the drawing show individual measurements values, while the lines show the average of each region. The area where electromagnetic waves are present is shown in shades of gray.

### Embodiment 2

The top cover of the transparent cavity 4 is closed.

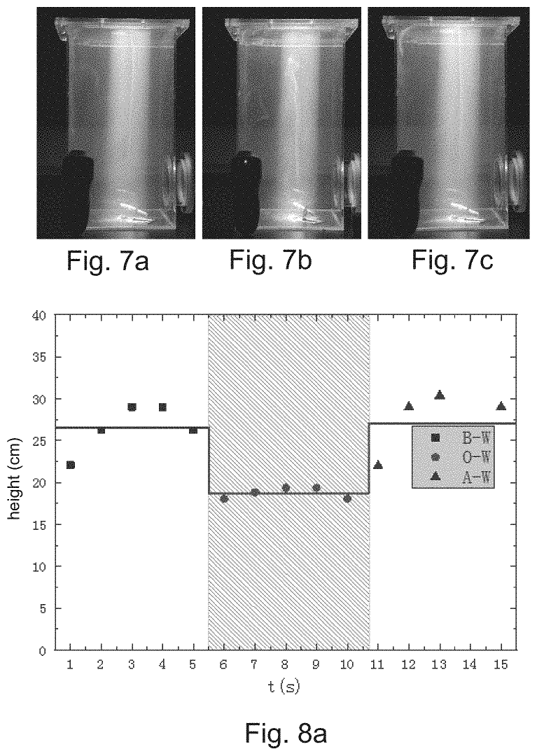

When the top cover is closed, the experimental cavity 4 is completely closed. The weak flow field instability caused by the difference in concentration produced by the smoke and the surrounding air causes a weak disturbance in the plume, resulting in a weak oscillation of the plume at the point where the original laminar flow occurs and the plume flow entering the transition state. As the smoke continues to grow, the concentration-related disturbances gradually decrease, and the plume airflow slowly returns to a stable laminar flow. When a flow state is stable, electromagnetic radiation is turned on, causing severe irregular oscillations in the plume flow and producing a turbulent state that is more easily maintained in the presence of electromagnetic waves. As in the previous experiment, when the radiation exists, the plume airflow becomes very wide, and when the radiation is turned off, the plume airflow quickly returns to its original state, wherein and the result is shown in FIGS. 7a-7c. FIG. 7a shows the plume flow before the electromagnetic radiation is turned on. FIG. 7b shows the plume flow 1 second after the radiation is turned on. FIG. 7c shows the plume flow 2 seconds after the radiation is turned off again. White light columns are for lighting only. The red dot on the microwave leak detector in FIG. 7b indicates the presence of electromagnetic waves. The laminar flow height change of the plume over time is shown in FIG. 8b, wherein the x-axis and the y-axis respectively show time (s) and laminar flow height (cm). Changes are significant before the electromagnetic radiation is turned on (B-W, square), during the electromagnetic radiation is turned on (O-W, dot), and after the electromagnetic radiation is turned off again (A-W, triangle). The discrete points in the drawing show individual measurements values, while the lines show the average of each region. The area where electromagnetic waves are present is shown in shades of gray.

Referring to FIGS. 7a-7c and FIGS. 8a-8b, whether the top cover of the experimental cavity 4 is closed has a slight influence on the plume airflow, but does not affect the plume height change caused by the electromagnetic wave. The electromagnetic induction switch of the present invention can adopt a closed smoke space or an opened smoke space.

One skilled in the art will understand that the embodiment of the present invention as shown in the drawings and described above is exemplary only and not intended to be limiting. Therefore, this invention includes all modifications encompassed within the spirit and scope of the following claims.

What is claimed is:

1. An electromagnetic wave induction device, comprising a smoke space limited by a cavity in which charge-carrying smoke is disposed.

2. The electromagnetic wave induction device, as recited in claim 1, further comprising an image signal collector and an image signal analyzer, wherein the image signal collector collects an image signal of the smoke, and transmits the image signal to the image signal analyzer; the image signal analyzer analyzes laminar flow height changes of the smoke.

3. The electromagnetic wave induction device, as recited in claim 1, wherein the smoke is produced by burning a combustion material which is selected from a group consisting of coal, wood, cotton, hemp, paper and cigarettes.

4. The electromagnetic wave induction device, as recited in claim 1, wherein the cavity has a top cover which is slidable, and guide rails are respectively provided at opposite sides on a top of the cavity; the top cover is slidable along the guide rails to open or close the cavity.

5. The electromagnetic wave induction device, as recited in claim 1, wherein a combustion material is burnt to produce white smoke.

6. An electromagnetic induction switch, comprising an electromagnetic wave induction device as recited in claim 1, an electromagnetic signal transmitter, an image signal collector and an image signal analyzer.

7. The electromagnetic induction switch, as recited in claim 6, wherein the electromagnetic signal transmitter is a klystron, a magnetron or an effect tube.

8. The electromagnetic induction switch, as recited in claim 6, wherein the electromagnetic signal transmitter transmits a modulated electromagnetic wave.

9. The electromagnetic induction switch, as recited in claim 6, further comprising an illuminating system.

10. The electromagnetic induction switch, as recited in claim 6, further comprising an antenna, wherein a smoke space is placed in a transmitting antenna far field region, and a power density in a cavity is not less than 10 mw/cm².
